(19) United States
(12) Patent Application Publication
(10) Pub. No.: US 2011/0052760 A1
(43) Pub. Date: Mar. 3, 2011

(54) SOUP OR SAUCE COMPOSITION AND PROCESS FOR ITS PRODUCTION

(75) Inventors: Ellen Maria Elizabeth Mulder, Wormerveer (NL); Miriam Aldegonda Josephina Van Wanroij, Wormerveer (NL); Jeroen Monster, Wormerveer (NL); Ulrike Schmid, Wormerveer (NL)

(73) Assignee: LIPID NUTRITION B.V., Wormerveer (NL)

(21) Appl. No.: 12/740,207

(22) PCT Filed: Oct. 22, 2008
(86) PCT No.: PCT/EP2008/008915

§ 371 Date: Aug. 11, 2010

(30) Foreign Application Priority Data
Oct. 29, 2007 (EP) 07254273.1

(51) Int. Cl. A23L 1/39; A23L 1/40; A23L 1/302; A23L 1/30

(52) U.S. Cl. 426/72; 426/589; 426/541; 426/442

(57) ABSTRACT

A soup or sauce comprising: water; one or more components selected from meat ingredients, vegetable ingredients and carbohydrates; and from 0.5 to 20% by weight added fat, wherein said fat comprises at least 5 to 35% by weight pinolenic acid.

This invention relates to a soup or sauce composition and to a process for its production.

The nutritional value of the diet has come under increasing scrutiny. Food supplements are often taken by individuals in order to obtain nutritional benefits. However, food supplements are typically in the form of capsules or the like and have the disadvantage that they are inconvenient in that an individual has to remember to take them. Food supplements of this type are typically not flavoured and are not attractive to many consumers.

Nutritional supplements have been incorporated into food products but the resulting food products can have an undesirable taste and the incorporation of the supplement can have a deleterious effect on the stability of the products.

Pinolenic acid (i.e., 5, 9, 12 C18:3 fatty acid, a fatty acid with 18 carbon atoms having three cis double bonds in the positions 5, 9 and 12) is present in, for example, pine nut oil and fractions thereof (see J Am Oil Chem Soc 1998, 75, p. 45-50). Pinolenic acid, as a highly unsaturated fatty acid, can be expected to suffer from the problem of low oxidative stability, particularly when incorporated into foods and soup or sauces.

EP-A-1685834 relates to the use of pinolenic acid and its derivatives for weight management by reducing the feeling of hunger and/or increasing satiety. A variety of product forms are mentioned.

EP-A-1129711 describes the use of pinolenic acid in the treatment of diabetes.

EP-A-1088552 discloses compositions containing pinolenic acid and their use as an anti-inflammatory agent.

U.S. Pat. No. 5,972,408 discloses a pesto sauce comprising pine nuts.

U.S. Pat. No. 5,370,896 discloses a sauce or soup comprising from 2% to 10% by weight of fat droplets as an emulsion in an aqueous base.

U.S. Pat. No. 4,840,806 discloses a tomato sauce comprising soybean oil.

Recipes for soups containing pine nuts are disclosed at http://www.vinidelsannio.it/index.php?tipo=contenuto&ID=107&ID1=41&ID2=0&ID3=0&subpage=true and http://www.soupsong.com/rpinenut.html.

It has now been found that a convenient vehicle for the consumption of pinolenic acid and its derivatives can be provided by certain soup or sauces. Surprisingly, it is possible to incorporate the pinolenic acid or derivative in these compositions in relatively high amounts and yet still achieve good oxidative stability compared to other, less unsaturated oils or oils having the same amount of unsaturation. The compositions also have good organoleptic properties (including taste and texture) and good stability. Additionally, it is possible for the compositions to have a low calorie content and still achieve these advantages.

Accordingly, the present invention provides a soup or sauce comprising: water; one or more components selected from meat ingredients, vegetable ingredients and carbohydrates; and from 0.5 to 20% by weight added fat, wherein said fat comprises from 5 to 35% by weight pinolenic acid.

In another aspect, the invention comprises a composition which, upon rehydration with water, forms a soup or sauce according to the invention.

A further aspect of the invention is a process for producing a soup or sauce according to the invention or a composition according to the invention, which comprises adding to one or more components selected from water, meat ingredients, vegetable ingredients and carbohydrates, from 0.5% to 20% by weight fat, wherein said fat comprises from 5 to 35% by weight pinolenic acid.

Yet another aspect of the invention is the use of a soup or sauce composition according to the invention for a nutritional benefit.

In another aspect, the invention provides the use of a fat comprising from 5 to 35% by weight pinolenic acid in a soup or sauce.

In a further aspect, the invention provides the use of a fat comprising from 5 to 35% by weight pinolenic acid in a soup or sauce for improving the appearance and/or the organoleptic properties of the soup or sauce, preferably for improving the creaminess of the soup or sauce.

The soup or sauce of the invention comprises one or more components selected from meat and vegetable ingredients and carbohydrates. Suitable meats include, for example, beef, chicken, lamb and pork (such as ham), and the term “meat” in this context also includes fish and shellfish. The term “vegetable” is used in a culinary sense and includes any parts of an edible plant or fungus. Suitable vegetables include, for example, tomato, carrot, leek, onion, mushroom, pea, pumpkin, potato, cucumber, mint, asparagus, bean, lentil, chickpea, spices (such as nutmeg and pepper), pine nuts and mixtures thereof. Meat and vegetables are in a form that is suitable for incorporation into soups and sauces, such as in dried and/or comminuted forms, as will be well-known to those skilled in the art. The soups and sauces may contain one or more vegetable ingredients and/or one or more meat ingredients. Particularly preferred soups are those that comprise tomato and mushroom, particularly preferred sauces are those that comprise tomato. Preferably, the soup is a tomato or mushroom soup and the sauce is a tomato sauce.

Preferably, the sauce or soup of the invention does not comprise pine nuts or non-fat, preferably solid, material derived from pine nuts.

Carbohydrates may be used singly or as a mixture of two or more carbohydrates. Preferred carbohydrates for use in the soup or sauce of the invention include sucrose, starch, modified starch, xanthan and mixtures thereof. At least part of the carbohydrate may be provided by flour.

The soup or sauce of the invention comprises from 0.5% to 20% by weight added fat, more preferably from 0.6 to 19%, such as from 0.7 to 18%, more preferably from 0.9 to 15%, even more preferably from 1 to 10%, such as from 1.5 to 5% by weight added fat. The fat comprises from 5 to 35% by weight pinolenic acid, based on the total fatty acids (i.e., C12 to C24 carboxylic acids) present in the fat, more preferably from 7 to 30%, even more preferably from 10 to 20% by weight pinolenic acid, based on the total fatty acids (i.e., C12 to C24 carboxylic acids) present in the fat. Typically, the pinolenic acid will be present in the fat in the form of a glyceride, such as a triglyceride. The term “added fat” refers to fat that does not form part of any vegetable and/or meat ingredients or the carbohydrate or any other components of the soup or sauce. For example, the fat is added separately from any pine nuts that are present in the soup or sauce. The fat typically comprises at least 80% by weight or at least 90% by weight, such as at least 95% by weight of triglycerides. The fat may be pine nut oil.

Preferably, the soup or sauce of the invention comprises from 1% to 10% by weight carbohydrates and from 0.5% to 10% by weight protein.

Sources of protein for the soups and sauces of the invention are preferably selected from the group consisting of whey solids, skimmed milk powder, soya protein, low fat yoghurt, skimmed milk and mixtures thereof.

The soup or sauce may comprise an added fat A and a further fat B, wherein fat A comprises from 5 to 35% by weight pinolenic acid and fat B is selected from the group consisting of: dairy fats-(such as butter; cream and sour cream); cocoa butter equivalents, cocoa butter, palm oil or fractions thereof, palm kernel oil or fractions thereof, interesterified mixtures of above fats or fractions or hardened components thereof; liquid oils, such as sunflower oil, high oleic sunflower oil, soybean oil, rapeseed oil, cottonseed oil, safflower oil, high oleic safflower oil, olive oil, flaxseed oil, maize oil or MCT oils; and mixtures thereof. Fat B does not form part of the “added fat” as defined herein. Fat A may be mixed with fat B prior to addition to the soup or sauce or fat A and fat B can be included separately. Typically, the weight ratio of fat A to fat B is from 100:1 to 1:10, more preferably from 10:1 to 1:2, such as from 5:1 to 1:1.

Examples of fatty acids that may be present in the fat B, in addition to or separate from other saturated and unsaturated fatty acids, include linoleic acid, oleic acid, arachidonic acid, taxoleic, juniperonic, sciadonic, conjugated linoleic acid, an enriched isomer mixture of conjugated linoleic acid, EPA (eicosapentaenoic) and DHA (docosahexaenoic). These fatty acids will usually be present in the form of glycerides.

Preferably, the soup or sauce comprises from 0.5 to 10% by weight of protein. The protein can be added as such in a relatively concentrated from (e.g., having a protein content of greater than 70% by weight) or may form part of another material that is included in the composition, such as milk or yoghurt, for example. Preferably, the protein is selected from the group consisting of whey solids, skimmed milk powder and soya protein, cream, sour cream, low fat yoghurt, skimmed milk and mixtures thereof.

Soups or sauces of the invention preferably comprise at least 60% by weight of water, more preferably at least 70% by weight water, even more preferably from 80 to 95% by weight water. Water can be included as relatively pure water or as part of another material such as, for example, milk or yoghurt.

The soups and sauces preferably contain carbohydrates. Carbohydrates have the general formula CₙH₂ₙOₙ and are divided in three main groups: monosaccharides, disaccharides and polysaccharides. Examples of suitable monosaccharides include glucose, galactose, and fructose. Suitable disaccharides can be sucrose, lactose and maltose. Examples of polysaccharides often referred to as fibers or used as thickeners include starch, cellulose, pectin, glycogen, xanthan, gum acacia, modified food starches (e.g., alkenylsuccinate modified food starches), anionic polymers derived from cellulose (e.g. carboxymethylcellulose), gum ghatti, modified gum ghatti, xanthan gum, tragacanth gum, guar gum, locust bean gum, pectin, gelatine, carrageenan and mixtures thereof. Preferred carbohydrates for use in the soup or sauce of the invention include sucrose, starch, modified starch, xanthan and mixtures thereof.

Typical amounts of carbohydrates are from 1.0 to 10% by weight of the compositions.

This invention includes a soup or sauce composition comprising on dry basis 3 to 40% added fat, wherein said fat comprises from 5 to 35% by weight pinolenic acid.

Soups and sauces of the invention may include one or more solids such as meat or vegetable pieces, pasta or noodles.

The soups and sauces of the invention may be formed from a composition of the invention upon rehydration with water. Such compositions are also known as dried or instant soups and sauces. Typically, the water that is used for reconstitution is hot water. The compositions are typically adapted for reconstitution with a volume of water in the range of from 100 ml to 500 ml. These compositions preferably comprise on dry basis 3 to 40% added fat, wherein said fat comprises from 5 to 35% by weight pinolenic acid.

It has been found that by combining the soup or sauce ingredients according to the invention and adapting the level of pinolenic acid or derivative in the fat phase, it is possible to obtain a soup or sauce having one or more of: improved taste; stability in that there is little phase separation; no problems with aggregation and/or flocculation of particulate matter; no creaming; good homogeneity; enhanced viscosity; good colour; balanced flavour; little or no aftertaste; and an optimal droplet size distribution. Many or all of these positive effects preferably persist over time e.g., all of the effects remain positive over a period of at least 3 months, preferably about 6 to 12 months. Surprisingly, these positive attributes can be achieved in soups and sauces having relatively low energy contents. This means that it is possible to produce a low calorie product comprising pinolenic acid.

Moreover, despite the level of unsaturation of pinolenic acid, the soups and sauces have unexpectedly good oxidative stability when compared to other oils, such as high oleic sunflower oil, or sunflower oil.

A synergistic nutritional effect may also be present between the fat phase of the soups/sauces and other components in the soups/sauces, for example vegetable puree, extra vitamins. An example of such an effect is an enhancement of the weight management effect due to a feeling of satiety.

Preferably, the soup or sauce composition of the invention is a low calorie product. For example, the soup or sauce composition may have an energy content of less than 100 kcal/100 g, more preferably less than 80 kcal/100 g, even more preferably from 55 to 75 kcal/100 g. Calorie contents can be determined by methods well known to those skilled in the art, for example, as set out in Mullan, 2006, Labelling Determination of the Energy Content of Food: http://www.dairyscience.info/energy_label.asp#3 and/or FAO Food And Nutrition Paper 77, Food energy-methods of analysis and conversion factors, Report of a Technical Workshop, Rome, 3-6 Dec. 2002, Food And Agriculture Organization of the United Nations, Rome, 2003, ISBN 92-5-105014-7.

Soup or sauce compositions of the invention optionally comprise one or more additional additives selected from flavours, colouring agents, vitamins, minerals, acidity regulators, preservatives, emulsifiers, antioxidants, and mixtures thereof. Each of these materials may be a single component or a mixture of two or more components.

Examples of suitable vitamins and minerals include calcium, iron, zinc, copper, phosphorous, biotin, folic acid, pantothenic acid, iodine, vitamin A, vitamin C, vitamin B1, vitamin B2, vitamin B3, vitamin B6, vitamin B9, vitamin B12, vitamin D, vitamin E, and vitamin K. Preferably, wherein a vitamin or mineral is utilized the vitamin or mineral is selected from iron, zinc, folic acid, iodine, vitamin A, vitamin C, vitamin Be, vitamin B3, vitamin B6, vitamin B12, vitamin D, and vitamin E.

Acidity regulators include organic as well as inorganic edible acids. The acids can be added or be present in their undissociated form or, alternatively, as their respective salts, for example, potassium or sodium hydrogen phosphate, potassium or sodium dihydrogen phosphate salts. The preferred acids are edible organic acids which include citric acid, malic acid, fumaric acid, adipic acid, phosphoric acid, gluconic acid, tartaric acid, ascorbic acid, acetic acid, phosphoric acid, or mixtures thereof. Glucono Delta Lactone (GDL) may also be used, particularly wherein it is desired to reduce pH without introducing excessive acidic, or tart, flavour in the final composition.

Preservatives may be selected from the group consisting of sorbate preservatives, benzoate preservatives, and mixtures thereof.

Antioxidants include, for example, natural or synthetic tocopherols, TBHQ, BHT, BHA, free radical scavengers, propylgallate, ascorbylesters of fatty acids and enzymes with anti-oxidant properties.

The soup or sauces of the invention may be free of dairy material and, for example, may be free of lactose.

The soup or sauce composition may be produced by a process which comprises adding to one or more components selected from water, meat ingredients, vegetable ingredients and carbohydrates, from 0.5% to 20% by weight fat, wherein said fat comprises from 5 to 35% by weight pinolenic acid. Any remaining components are added thereafter.

A preferred process of the invention comprises:
(i) forming an emulsion of the fat in water in the presence of a protein;
(ii) forming a dispersion or solution of a carbohydrate in water;
(iii) optionally adding one or more additional ingredients;
(iv) mixing the compositions prepared in steps (i) and (ii) under shear;
(v) optionally homogenising and/or pasteurising; and
(vi) optionally cooling.

Pinolenic acid or a derivative of pinolenic acid (such as a glyceride e.g., a triglyceride) is an essential component of the compositions of the invention. Sources of pinolenic acid and its derivatives are available and will be known to those skilled in the art. Preferably, the pinolenic acid or derivative is in the form of pine nut oil or is derived from pine nut oil.

The pinolenic acid or derivative in the soup or sauce compositions may form part of a fat composition that comprises one or more other components. The fat will typically be present in the soup or sauce composition in the form of an emulsion, suspension or dispersion. The fat is generally present homogeneously throughout the aqueous phase of the soup or sauce.

Examples of other fatty acids that may be present in the fat include linoleic acid, oleic acid, taxoleic, juniperonic, sciadonic, saturated fatty acids, conjugated linoleic acid (optionally as an enriched isomer mixture), arachidonic acid, EPA (eicosapentaenoic) and DHA-(docosahexaenoic).

Particularly preferred fats used in soup or sauce compositions of the invention are those in which the pinolenic acid or derivative is in the form of a composition which additionally comprises from 30 to 70% by weight linoleic acid or derivative thereof, based on the total weight of fatty acids in the fat (calculated as free fatty acid). Additionally or alternatively, the pinolenic acid or derivative is in the form of a fat which additionally comprises from 10 to 40% by weight oleic acid or derivative thereof, based on the total weight of fatty acids in the fat (calculated as free fatty acid). Additionally or alternatively, the pinolenic acid or derivative is in the form of a fat which additionally comprises from 1 to 15% by weight palmitic acid or derivative thereof, based on the total weight of fatty acids in the fat (calculated as free fatty acid). Additionally or alternatively, the fat may comprise from 0.5 to 5 wt % of taxoleic acid or a derivative thereof.

Specific examples of fats comprising pinolenic acid or a derivative thereof that are useful in the invention include the following:
Fat compositions comprising from 10 to 35%, more preferably from 15 to 30%, by weight pinolenic acid or a derivative thereof, together with from 30 to 70% by weight linoleic acid or a derivative thereof;
Fat compositions comprising from 10 to 35%, more preferably from 15 to 30%, by weight pinolenic acid or a derivative thereof, together with from 10 to 40% by weight oleic acid or a derivative thereof;
Fat compositions comprising from 10 to 35%, more preferably from 15 to 30%, by weight pinolenic acid or a derivative thereof, together with from 1 to 15% by weight palmitic acid or a derivative thereof;
Fat compositions comprising from 10 to 35%, more preferably from 15 to 30%, by weight pinolenic acid or a derivative thereof, together with from 0.5 to 5 wt % of taxoleic acid or a derivative thereof;
Fat compositions comprising from 10 to 35%, more preferably from 15 to 30%, by weight pinolenic acid or a derivative thereof, together with from 30 to 70% by weight linoleic acid or a derivative thereof and from 10 to 40% by weight oleic acid or a derivative thereof;
Fat compositions comprising from 10 to 35%, more preferably from 15 to 30%, by weight pinolenic acid or a derivative thereof together with from 30 to 70% by weight linoleic acid or a derivative thereof and from 1 to 15% by weight palmitic acid or a derivative thereof;
Fat compositions comprising from 10 to 35%, more preferably from 15 to 30%, by weight pinolenic acid or a derivative thereof together with from 30 to 70% by weight linoleic acid or a derivative thereof and from 0.5 to 5 wt % of taxoleic acid or a derivative thereof;
Fat compositions comprising from 10 to 35%, more preferably from 15 to 30%, by weight pinolenic acid or a derivative thereof together with from 30 to 70% by weight linoleic acid or a derivative thereof, from 1 to 15% by weight palmitic acid or a derivative thereof and from 10 to 40% by weight oleic acid or a derivative thereof; and

Fat compositions comprising from 10 to 35%, more preferably from 15 to 30%, by weight pinolenic acid or a derivative thereof, together with from 30 to 70% by weight linoleic acid or a derivative thereof, from 1 to 15% by weight palmitic acid or a derivative thereof, from 10 to 40% by weight oleic acid or a derivative thereof and from 0.5 to 5 wt % of taxoleic acid or a derivative thereof.

In these fats and other aspects of the invention, the amounts of the acids or derivatives are determined by GC FAME. Preferably, the fatty acids are present as glycerides (more preferably triglycerides) (i.e., more than 90%, preferably more than 95%, by weight of the fatty acids are present as glycerides, more preferably triglycerides). Another preferred glyceride is the diglyceride.

In a preferred embodiment of the invention, the pinolenic acid or derivative represents at least 75% by weight of the total Δ5-polyunsaturated C18-C20 fatty acids in the fat (calculated as free fatty acid).

A suitable source for the pinolenic acid used in the present invention is pine nut oil or concentrates thereof. For example, glycerides of pinolenic acid can be obtained from pine nut oil or concentrates thereof. An oil or concentrate with a content of pinolenic acid or a derivative thereof of more than 15% by weight or more than 28% by weight may be used (such as up to 50% by weight).

Concentrates of pinolenic acid or a derivative thereof that may be used in the present invention can be prepared by any suitable process. A suitable process is described in EP-A-1088552.

The fats comprising pinolenic acid or a derivative thereof that are useful in the invention may comprise one or more other fatty acids. The term fatty acid, as used herein, refers to straight chain carboxylic acids having from 12 to 24 carbon atoms and being saturated or unsaturated e.g., having 0, 1, 2 or 3 double bonds. Pinolenic acid derivatives, as referred to herein, include glycerides, preferably triglycerides.

The pinolenic acid or derivative thereof is optionally blended with additional fatty acids or glycerides before being used in the fat of the present invention. When the compositions contain one or more fatty acids and/or glycerides in addition to the pinolenic acid or derivative thereof, the additional fatty acid(s) and/or glycerides are preferably selected from liquid oils, such as soybean oil, sunflower oil, rape seed oil and cotton seed oil; cocoa butter and cocoa butter equivalents; palm oil and fractions thereof; enzymically made fats; fish oils and fractions thereof; conjugated linoleic acid and enriched isomer mixtures; gamma linolenic acid and enriched mixtures thereof; hardened liquid oils; and mixtures thereof.

The pinolenic acid or derivative thereof can be included in the soup or sauce of the invention as an oil or in the form of a powder, such as a free flowing powder. Pinolenic acid and its derivatives in powder form can be produced, for example, by spray drying pinolenic acid or its derivatives, or a fat comprising pinolenic acid or its derivatives, with protein and/or carbohydrate, with the powder typically comprising from 50 to 90% of fat. It has been found that use of the powder can give extra stability to the soup or sauce.

The listing or discussion of an apparently prior-published document in this specification should not necessarily be taken as an acknowledgement that the document is part of the state of the art or is common general knowledge.

The following non-limiting examples illustrate the invention and do not limit its scope in any way. In the examples and throughout this specification, all percentages, parts and ratios are by weight unless indicated otherwise.

### EXAMPLES

### Example 1

Tomato soup

| % by weight | Ingredient |
|---|---|
| 52 | Tomato |
| 2 | PinnoThin ™ |
| 1.5 | Butter |
| 2.7 | Modified starch |
| 3.5 | Sucrose |
| 1 | Skimmed milk powder |
| 0.04 | Basil |
| 0.38 | Salt |
| To 100% | Water |

PinnoThin is a mixture of triglycerides and is a trademark of Lipid Nutrition BV (Wormerveer, The Netherlands) and has the following fatty acid profile determined by FAME:

| | |
|---|---|
| Pinolenic acid | 16 |
| Linoleic acid | 46 |
| Oleic acid | 25 |
| Palmitic acid | 4 |
| Taxoleic acid | 2 |
| Others | balance to 100 |

### Example 2

White sauce

| % by weight | Ingredient |
|---|---|
| 3.5 | PinnoThin ™ |
| 2.5 | Modified starch |
| 2.5 | Flour |
| 3.5 | Sucrose |
| 0.3 | Xanthan |
| 4.6 | Milk protein |
| 0.04 | Nutmeg |
| 0.38 | Salt |
| To 100% | Water |

### Example 3

### Tomato Sauce Showing the Effect of Pinolenic Acid

Two tomato sauces were prepared to show the effect of pinolenic acid (as the triglyceride) at a level of 4% by weight compared to a lower level in combination with another fat conventionally used in food products i.e., sunflower oil. The sauces were prepared as follows.

A tomato sauce (Buon Appetito tomatensaus (sugo di mamma) having a calorie content of 38 kcal/100 g, 1.5 g protein/100 g, 6.9 g carbohydrate/100 g and 0.3 g fat/100 g) was homogenized by using an Ultra Turrax (200/50 bar). Solid particles were removed by filtration. The sauce was warmed up to 50° C. and divided into two parts (A and B). At 50° C. to sauce A 0.5% by weight PinnoThin™ and 3.5% by weight sunflower oil were added and to sauce B 4% by weight of PinnoThin™ was added by using an Ultra Turrax (200/50 bar).

Sauce A and sauce B were assessed by a group of six trained panellists who rated the sauces on a scale of from 0 to 100 (with 100 being the greater creaminess, odour and taste). The average values were calculated.

The results were as follows:

| | Sauce A (comparative) | Sauce B (invention) |
|---|---|---|
| Appearance | 46.6 | 50 |
| (creaminess) | | |
| Odour-tomato | 50 | 49.1 |
| Odour-PinnoThin | 0 | 5 |
| Taste-tomato | 53.3 | 46.6 |
| Taste-PinnoThin | 7.5 | 15 |
| Taste (creaminess) | 37.5 | 46.6 |
| Overall taste | Not acceptable | Acceptable |

### Conclusions:

Sauce comprising 4% PinnoThin appears to be more creamy than sauce comprising 3.5 sunflower oil and 0.5% PinnoThin
Sauce comprising 4% PinnoThin tastes more creamy than sauce comprising 3.5% sunflower oil and 0.5% PinnoThin
50% of the panellists found the taste of sauce A not acceptable

### Example 4

### Tomato Soup Showing the Effect of the Level of Pinolenic Acid

Three tomato soups were prepared to show the effect of different levels of added pinolenic acid (as the triglyceride) on the properties of soup. The soups were prepared as follows.

50% of water was added to the “ready to make” soup (California™ tomatensoep, having a calorie content of 25 kcal per serving, and containing, per serving, 0.5 g protein, 4.0 g carbohydrate and 0.5 g fat). The whole soup was filtered to remove solid particles. After filtration, the soup was warmed up to 50° C. and divided into three equal parts (A, B and C). To soup A, 0.2% by weight of PinnoThin™ was added, to soup B 4% by weight of PinnoThin™ was added and to soup C 24% by weight of PinnoThin™ was added. The addition of PinnoThin™ was performed at 50° C. by using an Ultra Turrax for homogenisation (200/50 bar).

Soups A, B and C were assessed by a group of six trained panellists who rated the sauces on a scale of from 0 to 100 (with 100 being the greater creaminess, odour and taste). The average values were calculated.

The results were as follows:

| | Soup A | Soup B | Soup C |
|---|---|---|---|
| Appearance (creaminess) | 29.1 | 57.7 | 57.1 |
| Odour-tomato | 58.1 | 36.1 | 28.6 |
| Odour-PinnoThin | 4.4 | 23.7 | 40.6 |
| Taste-tomato | 57.7 | 41.6 | 24.3 |
| Taste-PinnoThin | 6.6 | 36.2 | 56.5 |
| Taste (creaminess) | 33.2 | 58 | 71.6 |
| Overall taste preference | Less preferred | Most | Least |
| | | preferred | preferred |

Soup B provided a surprising increase in creaminess, both in appearance and taste, even at its relatively low level of pinolenic acid, with the effect being comparable to far higher levels of pinolenic acid.

1. A soup or sauce comprising: water; one or more components selected from meat ingredients, vegetable ingredients and carbohydrates; and from 0.5 to 20% by weight added fat, wherein said fat comprises from 5 to 35% by weight pinolenic acid.

2. A soup or sauce as claimed in claim 1 comprising from 1% to 10% by weight carbohydrates and from 0.5% to 10% by weight protein.

3. A soup or sauce as claimed in claim 1, comprising carbohydrates selected from the group consisting of sucrose, starch, modified starch, xanthan and mixtures thereof.

4. A soup or sauce of claim 1, which comprises one or more sources of protein selected from the group consisting of whey solids, skimmed milk powder, soya protein, low fat yoghurt, skimmed milk and mixtures thereof.

5. A soup or sauce of claim 1 comprising at least 60% by weight of water, preferably at least 70% by weight water.

6. A soup or sauce of claim 1, comprising an added fat A and a further fat B, wherein fat A comprises from 5 to 35% by weight pinolenic acid and fat B is selected from the group consisting of: dairy fats; cocoa butter equivalents, cocoa butter, palm oil or fractions thereof, palm kernel oil or fractions thereof, interesterified mixtures of above fats or fractions or hardened components thereof; liquid oils, and mixtures thereof.

7. A soup or sauce of claim 1 which has an energy content of less than 100 kcal/100 g, preferably less than 80 kcal/100 g, more preferably from 55 to 75 kcal/100 g.

8. A soup or sauce A soup or sauce of claim 1 comprising one or more additives selected from flavours, colouring agents, vitamins, acidity regulators, preservatives, emulsifiers, antioxidants, dietary fibres and mixtures thereof.

9. A soup or sauce of claim 1, wherein at least a portion of the added fat is incorporated in the soup or sauce in the form of a powder.

10. A soup or sauce as claimed in claim 9, wherein the powder is produced by spray drying a fat comprising pinolenic acid with protein and/or carbohydrate.

11. A soup or sauce of claim 1, which comprises from 1 to 10% by weight added fat.

12. A soup or sauce of claim 1, wherein said fat comprises from 10 to 20% by weight pinolenic acid.

13. A soup or sauce of claim 1, which is a vegetable soup.

14. A soup or sauce of claim 1, which is a tomato or mushroom soup.

15. A composition which, upon rehydration with water, forms a soup or sauce according to claim 1.

16. A process for producing a soup or sauce, comprising: adding to one or more components selected from water, meat ingredients, vegetable ingredients and carbohydrates, from 0.5% to 20% by weight fat, wherein said fat comprises from 5 to 35% by weight pinolenic acid.

17. A process for producing a soup or sauce, comprising:
forming an emulsion of the fat in water in the presence of a protein;
(ii) forming a dispersion or solution of a carbohydrate in water;
(iii) optionally adding one or more additional ingredients;
(iv) mixing the compositions prepared in steps (i) and (ii) under shear;
(v) optionally homogenising and/or pasteurising; and
(vi) optionally cooling.

18. (canceled)

19. (canceled)

20. (canceled)

21. (canceled)

22. A soup or sauce of claim 5 comprising 80 to 95% by weight water.

23. A soup or sauce of claim 6 wherein the dairy fat is butter, cream or sour cream.

24. A soup or sauce of claim 6 wherein the liquid oil is sunflower oil, high oleic sunflower oil, soybean oil, rapeseed oil, cottonseed oil, safflower oil, high oleic safflower oil, olive oil, flaxseed oil, maize oil or MCT oil.

25. A method for improving the appearance and/or the organoleptic properties of a soup or sauce, comprising: incorporating into the soup or sauce, a fat comprising from 5 to 35% by weight pinolenic acid.

26. The method of claim 25, wherein the fat is added to the soup or sauce in an amount of from 1 to 10% by weight.

27. The method of claim 25, wherein the fat comprises 10 to 20% by weight pinolenic acid.

28. A method for improving the creaminess of a soup or sauce, comprising: incorporating into the soup or sauce, a fat comprising from 5 to 35% by weight pinolenic acid.
